(19) United States
(12) Patent Application Publication
(10) Pub. No.: US 2006/0031520 A1
(43) Pub. Date: Feb. 9, 2006

(54) Allocation of common persistent connections through proxies

(75) Inventors: Anand S. Bedekar, Arlington Heights, IL (US); Rajeev Agrawal, Northbrook, IL (US); Peerapol Tinnakornsrisuphap, San Diego, CA (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/840,053

(22) Filed: May 6, 2004

(51) Int. Cl. G06F 15/16

(52) U.S. Cl. 709/227

(57) ABSTRACT

The present embodiments provide apparatuses, methods and systems for use in facilitating access with a distributed network. In some embodiments, and apparatus can comprise a controller, a plurality of persistent connections, and communication ports that receive requests for objects, wherein the requests are communicated over the plurality of persistent connections and the objects are received over the plurality of persistent connections, and at least two of the requests are received from two different client users and are communicated over the same persistent connection. In some implementations, the controller further dynamically adjusts the number of persistent connections. Some systems according to some embodiments can comprise a proxy and a plurality of persistent connections that are activated and maintained by the proxy. The proxy can further comprise a controller, memory and a load tracker, and in some instances a persistent connection controller and idle timer.

### FIELD OF THE INVENTION

The present embodiments provide methods and systems for use in providing access to resources distributed over a network, and more particularly provide methods and systems for use in providing access for client devices to resources distributed over a computer network, such as the Internet.

### BACKGROUND OF THE INVENTION

The Internet has become a primary source of information, services and other resources for millions of people around the world. Many users attempt to access information available over the Internet from wireless devices, such as wireless computers and wireless phones. The time needed to download some information from the Internet, especially by wireless devices, can be excessive due to data rates, the time to establish connections over the Internet, and other such factors.

As a result, often the information to be retrieved through client devices, especially wireless devices, can have relatively small data sizes. The small data sizes speed up the delivery process and reduces the amount of wireless time used in obtaining the data. Further; the amount of data viewable by many wireless devices, such as wireless phones, is limited, and thus the amount of data delivered is reduced to simplify the displaying of the data.

Because of the reduced data sizes being downloaded by wireless devices, a significant amount of the total delay associated with a download is often attributed to establishing a connection of the wireless devices to a data source, such as a web server. Such delays can significantly impact the user experience in an adverse manner and can frustrate users attempting to utilize wireless access.

### BRIEF DESCRIPTION OF THE DRAWINGS

The above needs are at least partially met through provisions of methods, apparatuses, and/or systems for use in providing client devices with access to data retrievable over a distributed network, such as the Internet, as described in the following detailed description, particularly when studied in conjunction with the drawings, wherein:

FIG. 1 depicts a simplified block diagram of a system according to some present embodiments that provides wireless devices with access and/or to retrieve objects over a distributed network;

FIG. 2 depicts a simplified block diagram of an apparatus according to some present embodiments that establishes connections for client devices over the Internet;

FIG. 3 depicts a simplified flow diagram of a process for transmitting a request to a server over persistent connections;

FIG. 4 depicts a simplified flow diagram of an algorithm or process for de-multiplexing received objects to ensure that objects are routed to the requested user;

FIG. 5 depicts a simplified flow diagram of a process for dynamically adjusting the number of persistent connections that are active;

FIG. 6 shows a flow diagram of a process for activating an idle timer;

FIG. 7 shows a flow diagram of a process for terminating a persistent connection;

FIG. 8 depicts a simplified block diagram of a proxy according to some embodiments; and

FIGS. 9-12 show simulation results of effective download speeds, based on total bytes transferred divided by the total time to transfer the data, versus average page size.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The present embodiments provide apparatuses, methods and systems for use in providing access to data, information and/or services available over a distributed network, and particularly access over the distributed network (such as the Internet) for client devices. In part, the present embodiments improve Internet access by utilizing persistent connections with servers or data sources distributed over a network such as the Internet. Persistent connections are connections that are maintained as active so that communications and/or requests can be forwarded over these connections without having to establish new connections and without having to go through a set-up process between the devices communicating. These embodiments can be utilized for substantially any relevant protocol, such as hypertext transfer protocol (HTTP) and wireless application protocol (WAP) such as WAP2.0. Some embodiments provide persistent connections that are established with transmission control protocol (TCP).

Further, the present embodiments employ proxies or other similar devices to establish connections over the Internet to access desired servers or other resources. Once connections are established, the proxies allow multiple users to access and utilize the established persistent connections or communication links. This significantly improves a user's or customer's access time to retain web pages and other information over the Internet.

The sizes of downloaded pages in wireless data network environments are often small. As such, the delay incurred through protocol overhead often causes the greatest percentage of delay. The present embodiments attempt to minimize the protocol overhead. TCP is the transport protocol for both HTTP and WAP2.0. To download a page or data using TCP, a client device and an Internet server cooperate to set-up a TCP connection by negotiating a three-way handshake as required by the TCP specification before data can be transferred. As a result, if the end-to-end round-trip delay is large, the three-way handshake adds excessive delays in the total time needed to download the requested page or data. The time for the TCP setup process could constitute most of the page transfer time and delay especially if the size of the requested page/data is small.

Some embodiments provide an apparatus for use in facilitating client access with a distributed network, where the apparatus can comprise a controller, a plurality of persistent connections, and communication ports that receive requests for objects retrievable over the distributed network. The requests are communicated over the plurality of persistent connections and the objects are received over the plurality of persistent connections. In some instances, at least two of the requests are received from two different users and are communicated over the same persistent connection where the different users can be wireless users. The controller can, in some embodiments, dynamically adjust the number of persistent connections. An idle timer can further be included in some implementations, where the controller activates the idle timer when a first persistent connection becomes idle, and terminates the first persistent connection when a predefined time period expires before a request for an object is communicated over the first persistent connections.

In some preferred implementations of the present embodiments, the controller can activate one or more additional persistent connections when one or more additional requests are received and the existing plurality of persistent connections are in use. When the additional persistent connections are established, the additional request can be routed over the additional persistent connection. The controller, in some embodiments, can alternatively and/or additionally distribute requests to be communicated over the plurality of persistent connections such the requests are routed to persistent connections having lightest loads.

Some embodiments provide systems for use in communicating data with client devices. These systems can include a proxy and a plurality of persistent connections over a distributed network that are activated and maintained by the proxy. The proxy can further comprise a controller, a memory comprising a cache, and a load tracker. In some implementations, the proxy further comprises a persistent connection controller and one or more idle timers, where an idle timer determines a period of time for which a first persistent connection is idle, and the persistent connection controller releases the first persistent connection when the first persistent connection is idle for a predefined period of time. The persistent connection controller can further activate an additional persistent connection when an additional request is received while all of the existing persistent connections are occupied or are loaded beyond an acceptable level. In some embodiments, the proxy further includes an object identification evaluator that identifies a user associated with a received object, and an object router that routes the received object to the user as identified by the object identifier.

Additional embodiments provide methods for use in providing client devices with access to a distributed network. These methods can establish a plurality of persistent connections over a distributed network, maintain the plurality of persistent connections as active, receive a plurality of requests for objects, and communicate the plurality of requests over the plurality of persistent connections where a first request and a second request are communicated over a first persistent connection. In many instances, the first request is received from a first client device and the second request is received from a second client device. The method in some embodiments further adjusts the number of persistent connections that are maintained as active. For example, the method can monitor a persistent connection, and release this persistent connection when the persistent connection is idle for a predefined period of time. In some embodiments, the method further receives an additional request, determines loading on each of the existing persistent connections, activate an additional persistent connection when the additional request is received while all of the existing persistent connections are in use, and routes the additional request over the additional persistent connection.

Standard proxies have been used to speed up client downloads for HTTP and/or WAP communications. A proxy provides functions such as caching, in which commonly requested HTTP objects (e.g., a web page) are stored in a cache and immediately transmitted to the user upon recognition of the request and verification of the contents in the cache without having to connect across the Internet to the web server. This avoids the TCP setup procedures as well as avoids much of the transmission delay. If the object requested by the user is not in the cache, the proxy alternatively initiates a new TCP connection for each request to the identified server (including TCP setup procedures) to complete the request. Thus, standard proxies do not avoid the delay incurred due to TCP's three-way handshake for objects not in the cache.

A rapidly growing portion of Internet traffic is dynamically generated for each user, and/or generated in real-time. As such, the benefits of traditional caching at a standard HTTP proxy are reduced because the pages for each individual are often different, and thus the delays incurred in setting up TCP connections become more prominent.

Further, server response times for setting up new connections under heavy traffic loads can become very slow. Often new connections could be rejected altogether when a server is overloaded.

The present embodiments alternatively provide one or more persistent connections such as persistent TCP connections that allow multiple users to utilize the connections. These persistent connections are maintained as active connections so that communications can be forwarded over these connections without having to establish new connections and without having to go through a set-up process between the devices communicating. This greatly reduces the delay time as a connection does not have to go through the TCP setup procedure. In some embodiments, these persistent connections are maintained between a proxy and a server. This allows multiple users to access the proxy, where the proxy can direct the multiple users to the one or more persistent connections. Some preferred embodiments further provide pipelining of multiple users over the same one or more persistent connections. This pipelining allows multiple requests from one or more users to be sent to the server without waiting for the responses to the previous requests to be received and/or downloaded.

It has been proposed, for example in the HTTP/1.1 specification, to allow a single user to pipeline communications through a single TCP connection to a single server. This pipelining, however, is presented only in the context of a single user/server transaction. The HTTP/1.1 specification fails to suggest the pipelining of multiple users over persistent connections, and further fails to suggest utilizing proxies in cooperation with pipelining requests from different users into common persistent TCP connections.

Commonly used proxy server software does not pipeline requests from the proxy to web servers. Alternatively, proxies typically open new connections with a server for each request. One previously proposed proxy might allow for the pipelining of requests from a single given client connection over a connection from the proxy to a server, even if the client does not use pipelining. This prior approach does not support the establishment of persistent connections. This proposed proxy also does not address the multiplexing of different users' requests into persistent TCP connections from the proxy to the server. Further, this prior approach fails to suggest the pipelining of multiple users over multiple different persistent TCP connections.

Further, pipelining requests of just one client connection into one server connection is inefficient because the connection remains idle for long periods of time. It is quite likely in this case that the server window will drop down before a new request is received, resulting in new downloads having to go through the slow TCP three-way handshake setup.

Alternatively as introduced above, the present embodiments provide apparatuses, such as proxies, that can be utilized by multiple users to access persistent connections (such as TCP connections) in requesting web pages, data, information and/or services (referred to below as objects) from servers over a distributed network such as the Internet. These apparatuses speed up and simplify the connection and communication between requesting devices and object sources. The persistent connections avoid the need to perform the three-way handshake set up and thus greatly reduce response time.

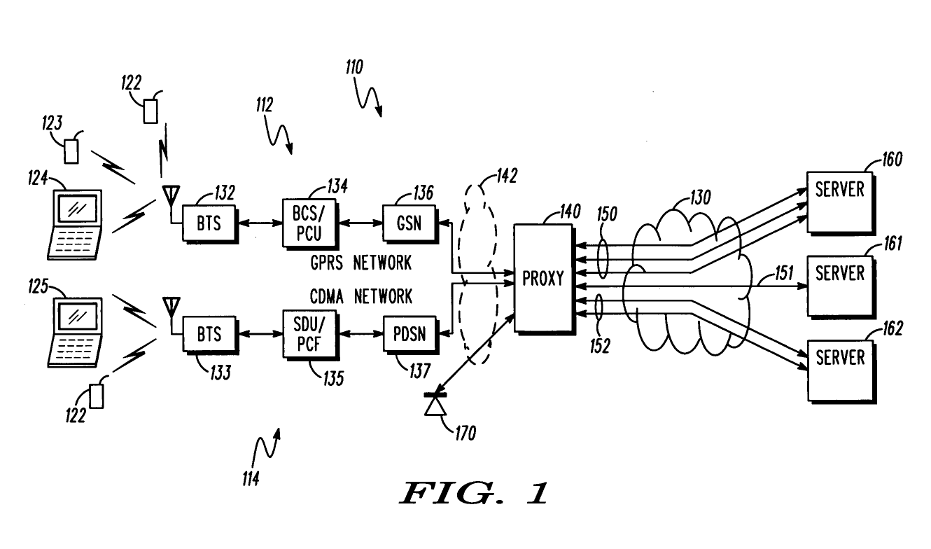

FIG. 1 depicts a simplified block diagram of a system 110 according to some present embodiments that provides client devices, such as wireless client devices 122-126 and wired client devices 170, with access to and/or to retrieve objects (e.g., data and web pages) over a distributed network 130, such as the Internet. The wireless client devices can be substantially any relevant wireless device, such as wireless computers, wireless mobile phones, personal digital assistances, pagers, and other such wireless devices capable of accessing data over distributed networks and/or the Internet. The system 110 can include one or more wireless networks 112, 114. These networks can employ substantially any relevant wireless communication service and/or protocol, such as Code-Division Multiple Access (CDMA), General Packet Radio Services (GPRS), and other similar systems.

The wireless devices wirelessly communicate with a base station, base transceiver station (BTS) and/or other similar wireless nodes 132, 133. The BTS 132, 133 in turn communicate with a base station controller or other communication controller 134, 135, such as packet control unit (PCU), selection function unit (SDU), packet control function (PCF), and other controllers and/or combination of communication controllers. The base station controller(s) can provide traffic control and/or routing between one or more BTS 132, 133. The base station controller further couples with and communicates with a general packet radio service (GPRS) support node (GSN) 136, a packet data service network or node (PDSN) 137 or other wireless network gateways. The GSN 136/PDSN 137 communicates with one or more apparatuses 140 providing connections over the distributed network 130, such as proxies 140. The coupling between the GSN/PDSN and the proxies can be through direct coupling or over a network or distributed network 142. In some implementations, the network 142 can be an intranet, the Internet 130, and other networks or combinations of networks. The proxy 140, in some embodiments, can further couple with hard wired networks (e.g., public switching telephone networks) and/or hardwired devices 170. The coupling with the wired device and/or network 170 can be direct coupling or through a distributed network 142.

The one or more proxies 140 communicate and/or establish communication links or connections 150-152 over the distributed network 130 (e.g., the Internet) between the proxy and one or more distributed servers or resources 160-162. The servers 160-162 can be substantially any type of server, such as Internet servers that distribute web sites, web content, and data accessible over the Internet.

The proxy 140 according to present embodiments can additionally provide traditional proxy functions. For example, in some embodiments, the proxy 140 can include a cache that stores web pages and/or data associated with requests from users, data compression and other similar proxy functions. If a request is received for an object stored within the cache, the proxy can immediately retrieve and deliver the requested information or object to the user without having to communicate with the server and without waiting for the data to be received from the server.

The communication connections 150-152 established by the proxy 140, in some instances, are preferably persistent connections. The proxy maintains these connections so that one or more clients or users (e.g., wireless devices 122-126) can utilize the persistent connections gaining quick access with the desired servers without the proxy (and/or the client device) having to implement the setup between the proxy and the server, such as the three-way TCP setup handshaking.

The proxy can establish substantially any number of persistent connections within the proxy, server and network capabilities. For example, a proxy can establish three persistent connections 150 between the proxy and a first server 160, one persistent connection 151 between the proxy and a second server 161, and two persistent connections 152 between the proxy and a third server 162. This is a simple example, and substantially any relevant number of persistent connections can be established between the proxy and substantially any number of servers. As another example, the proxy 140 can establish more than fifteen persistent connections between the proxy and the first server 160, no persistent connections with the second server 161, more than ten persistent connections with the third server 162, and persistent connections with other servers not shown. In some embodiments, the proxy dynamically adjusts the number of active persistent connections as fully described below.

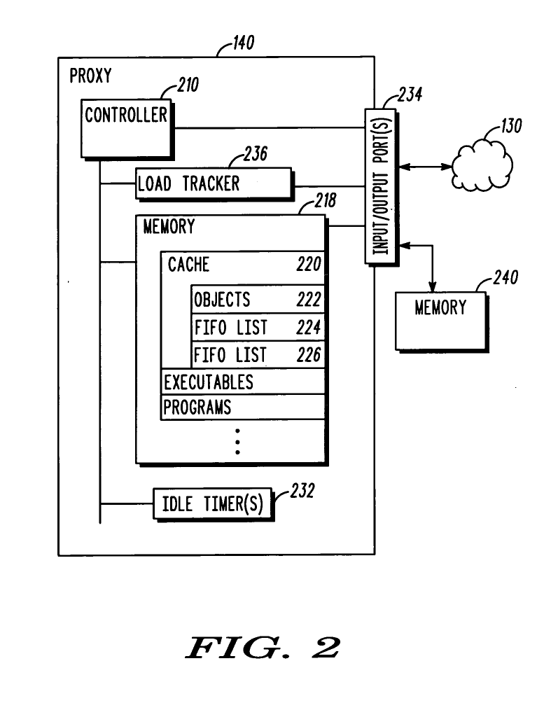

FIG. 2 depicts a simplified block diagram of an apparatus 140 according to some present embodiments establishing connections between wireless devices 122-126 with servers 160-162 and other resources distributed over a network, such as the Internet. In some preferred embodiments, the apparatus 140 is implemented through a proxy and/or other devices providing the below described functions. The proxy 140 allows multiple users 122-126 to access servers 160-162 over the distributed network 130 (see FIG. 1). The proxy 140 can include a controller 210 that provides overall control for the proxy. The controller 210 can be implemented though one or more microprocessors, computers, or other such controllers. In some embodiments, the controller can include one or more sub-controllers providing control for various operations and components of the proxy.

A memory 218 is included in the proxy to store data, programs, executables and other information used, forwarded to and/or retrieved by the proxy. The memory typically includes one or more caches 220 that store data, objects 222 received from servers 160, lists, identifiers and other such data and information. In some embodiments, the cache can include one or more first-in-first-out (FIFO) queues or lists 224, 226. The FIFO queues or lists 224, 226 can be used for numerous purposes, for example, the proxy 140 can use one FIFO queue or list 224 for retaining a request ID to aid in routing objects returned from servers to the requesting user. Other priority storage schemes can also be employed as are known in the art.

In some embodiments, the proxy can include one or more timers 232. For example one or more idle timers can be included that track how long a persistent connection is idle as described fully below. The proxy further includes a plurality of communication ports, e.g., input and output ports 234. The ports allow the proxy to receive requests from users, establish the one or more persistent connections over the network 130, receive objects requested, retrieve and/or receive information from other components of the system (such as receive additional programming upgrades, receive commands from a network controller and the like), and other similar functions.

The proxy 140 can, in some implementations, include a load tracker 236. The load tracker can identify idle persistent connections, keep track of or monitor the loads on each active persistent connection, and/or identify the persistent connection with the lightest load. The load tracker 236 can be separate from or part of the controller 210. Alternatively, the load tracker can be external to the proxy. The load tracker 236 can monitor the number of requests that are pending on each persistent connection, monitor the number of different users on connections, in some embodiments can estimate time to receive objects for requests, and/or other similar tracking. In some implementations, the proxy can couple with external memory 240 that can be used to store requested data, received objects, programming, executables, and other such data and information.

In some implementations of present embodiments, the proxy 140 establishes and maintains a fixed number of persistent connections (e.g., connections 150) with a server (e.g., server 160). As such, the proxy initiates the connection between the proxy 140 and the server 160 going through the connection setup (e.g., three-way TCP setup) for a predefined and fixed number of connections, such as one, three, five, ten, twenty connections or substantially any fixed number of persistent connections. Once the fixed number of connections are established, the proxy 140 maintains those connections as active and routes requests from users over the persistent connections without having to go through the setup with the server for each request from each user.

Some preferred implementations alternatively allow for the number of persistent connections to be dynamically controlled. As the demand increases, the number of persistent connections can be increased, and as the demand decreases the number of persistent connections can be reduced. Further, in some embodiments, the proxy can track the number of active requests on each of the persistent connections.

Once a request to access the server associated with the persistent connections is received from a user (e.g., mobile device 122 or wired device 170), the proxy can, in some embodiments, initially determine if the requested object is locally stored, for example, stored in a cache 220. If the object is stored, the proxy retrieves and immediately forwards the requested object without utilizing a persistent connection or without establishing a connection.

If the requested object is not stored in a cache, the proxy determines if a persistent connection is established between the proxy and the server containing the requested object. Once it is determined that one or more persistent connections are being maintained, the proxy can perform a load balancing for the one or more persistent connections, for example, by forwarding the request to an idle persistent connection or to the persistent connection with the lightest load.

Upon receipt of objects returned from servers, the proxy de-multiplexes the response to distribute the responses to the proper client/user, and in some embodiments, in a predefined order. To maintain the order of delivery to each client connection, the proxy can assign an identification number or string (ID) to each request. The proxy tracks the requests on each persistent connection and matches responses with the request IDs. For example, the proxy in some embodiments utilizes a first-in-first-out (FIFO) queue 224 of users' addresses and/or IDs and request IDs for each server connection. The user IDs also allow for the identification of a single user whose requests have been sent to the server using different persistent connections. A second list or FIFO queue 226 of request IDs for each client connection can also be stored in the cache 220 or other memory (e.g., memory 240). The stored request IDs enable delivery of received objects back to the requesting user, and in some embodiments back to the user in the order requested to by user. Some embodiments simplify the de-multiplexing or distributing of objects to the users by sending all requests from a user over the same persistent server connection. In that case the list or FIFO queue for each client connection may not be required.

The one or more FIFOs typically provide the priority in the order in which requests are received. Other priority schemes can additionally and/or alternatively be employed in assigning persistent connections and/or in de-multiplexing objects received from servers. In some embodiments, storage within memory 218/240 can be utilized to store user IDs, request IDs and other parameters. These parameters can be used for de-multiplexing when delivering objects to the client connection for alternative priority schemes that can be utilized instead of the FIFO priority and/or in cooperation with the FIFO priority. The storage for alternative priority schemes can be implemented through substantially any storage configuration, such as one or more heap data structures and/or substantially any other relative storage configurations.

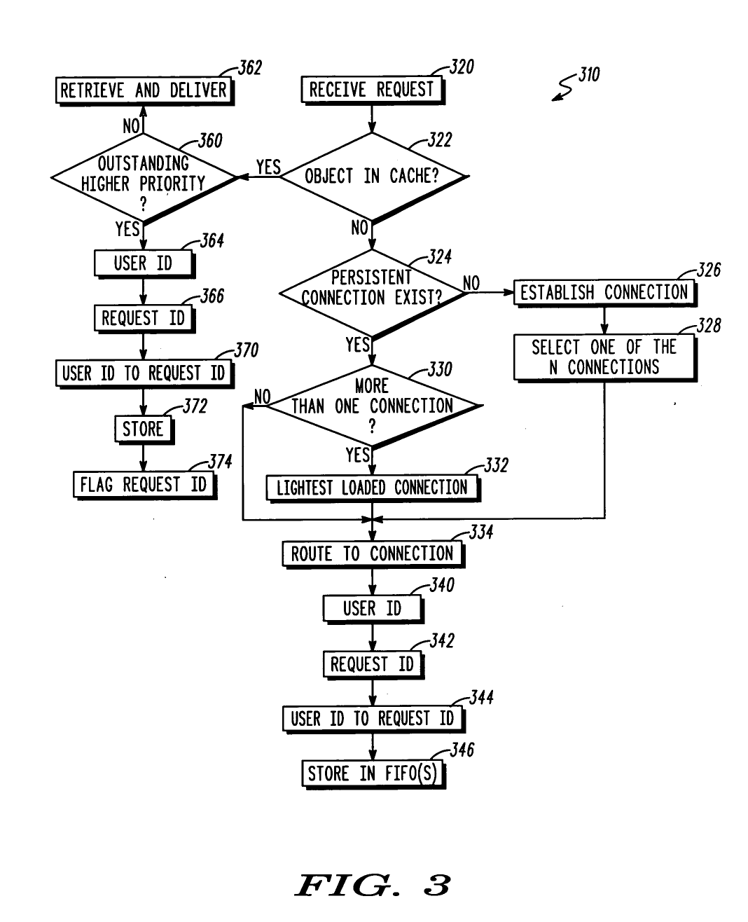

FIG. 3 depicts a simplified flow diagram of a process 310 for transmitting a request to a server over persistent connections. In step 320, a proxy receives a request for an object. In some instances, a request may include a request for more than one object. Some embodiments in these instances may separate these multiple object requests to different persistent connections. In step 322, the proxy determines if the requested object is stored in a cache (e.g., internal cache 220 and/or external cache 240). If the requested object is not in the cache, the process continues in some embodiments to step 324. If the requested object is found in the cache, there is no need to utilize a connection to the server to fetch the object, and the process can continue, in some embodiments, to step 360 where it is determined whether there are outstanding requests from the same user with higher priority than the current request as fully described below.

In step 324, the process 310 determines if a persistent connection exists between the proxy and the server containing the desired object. If a persistent connection does not exist, step 326 is entered where the proxy establishes a connection over the network between the proxy and the server associated with the request. This includes proceeding through the connection setup handshaking (e.g. three-way TCP setup) between the proxy and the server. The connection can be a standard connection or can be maintained as a persistent connection in some instances (e.g., if a predefined number of requests for the server have been received within a predefined period of time). Once the connection is established, the request is forwarded over the newly established connection. In some embodiments, the process further establishes request IDs and user IDs as described below.

In some implementations, a number N of persistent connections can be established when a request is received. For example, once a first request is received, the proxy can establish five persistent connections. In some instances, the proxy can initiate a fixed number of persistent connections in anticipation of users attempting to access a server. For example, the proxy can be triggered at a predefined time, such as at 3:30PM, to establish a fixed number of persistent connections to a server providing traffic information in anticipation of users attempting to get traffic information for their commute home. As another example, the proxy may be triggered to activate a fixed number of connections in anticipation of users attempting to access a scheduled event, such as a sporting event or other such scheduled events. Other similar circumstances and criteria can also be utilized in establishing the fixed number of connections. In step 328, the process further selects one of the N established connections. The process then proceeds to step 334 to route the request over the selected connection.

If it is determined in step 324 that at least one persistent connection exists with the requested server, the process enters step 330 where it is determined if there is more than one persistent connection. If there is not, the process proceeds to step 334. If there is more than one persistent connection, step 332 is entered where the connection having the lightest or smallest load is identified from the plurality of persistent connections.

In determining the smallest load, the proxy 140 and/or system 110 can employ any number of criteria to determine loading of persistent connections. In some instances, the proxy determines which of the plurality of persistent connections has the smallest number of outstanding requests, and routes the request to the smallest loaded connection, and preferably to a connection that is idle without any pending or outstanding requests. The proxy can use still other criteria and/or parameters to determining connection loading.

In some embodiments, the proxy can determine loading based in part on an amount of expected time to receive one or more objects from one or more pending request on each persistent channel. The proxy or proxies can, in some embodiments, monitor the requests and/or record requests. Further, the proxy can track the data size of a returned object, the time to receive a requested object, maintain an average time to receive an object (which may be further evaluated based on time of day, day of the week, and other such parameters), elapsed time for each request of a persistent connection, and other such criteria. The proxy can utilize the maintained criteria to estimate loads on persistent connections based on the types of outstanding requests as well as the number of outstanding requests. If the proxy anticipates a request will take an excessive amount of time because of the data size to be received from a request, the proxy can alternatively route a new request to an alternative persistent connection with a larger number of requests because the reduced expected time period for the alternative persistent connection to receive the outstanding requests.

Still referring to FIG. 3, once the proxy determines which of the plurality of persistent connections has the smallest load, step 334 is entered where the request is routed to the connection with the smallest load, or the one persistent connection if only a single persistent connection is available (as determined in step 330). In step 340 the proxy can generate an identification (ID) for user and/or user connection if a user ID has not previously been generated and recorded. For example, the proxy can identify a user's Internet Protocol address and TCP port number. In step 342, an ID for the request is generated. In step 344, the request ID is associated with the user ID and the persistent connection utilized in communicating the request. In step 346, the request ID is added to storage, for example in a list or FIFO queue, such as FIFO 224 of FIG. 2 associated with the persistent connection to which the request was routed (e.g., the connection determined to have the smallest load) and/or the user ID. The recorded request ID and the association of the request ID with the user ID allows for the returned object associated with the request to be accurately routed to the user as fully described below. In some embodiments, the user ID and the request ID can additionally be stored in the list or FIFO queue 226 associated with the client connection from which the request was received. This allows the returned object associated with the request to be delivered to the client connection in the proper order as fully described below.

Returning to step 360, if it is determined in step 322 that the requested object is in the cache, step 360 is entered where it is determined whether there are outstanding requests from the same client connection with higher priority than the current request. If there are no higher priority requests waiting, step 362 is entered where the object is returned from the cache to the requesting user. If it is determined in step 360 that there are higher priority requests pending, the process continues to step 364. In step 364 a user ID is generated if an ID has not already been generated. In step 366, an ID for the request is generated. The request ID can be based on the destination address attempting to be accessed, the user ID and/or source address, and other such data. In step 370, the request ID is associated with user ID. In step 372, the request ID is added to a priority list or queue associated with the user's client connection such that once all of the objects associated with higher priority requests are forwarded to the user, the current lower priority object can be forwarded from the cache.

In some embodiments, the process includes step 374 where one or more pending higher priority request IDs associated with the same user ID can be flagged to indicate that other objects with lower priority have been received and stored. Once an object of a flagged request ID is received, the system identifies a second request ID with the next lower priority and forwards the object associated with the second request ID. Again, the system determines if the second request ID is flagged, and repeats the process if the second request is flagged. The flagging of a request is described fully below.

The process 310 of FIG. 3 shows the IDs (user and/or request) generated after routing of the request. One or more of these IDs, however, can be generated at substantially any time during the process 310. For example, in some implementations, the IDs can be generated before communicating the request or even before checking the cache (step 322). Additionally and/or alternatively, the generation of the IDs can occur simultaneously with the checking of the persistent connections and loads, or during other portions of the process 310. In some embodiments, the request IDs that are active at a given time for a given user are distinct and different from each other.

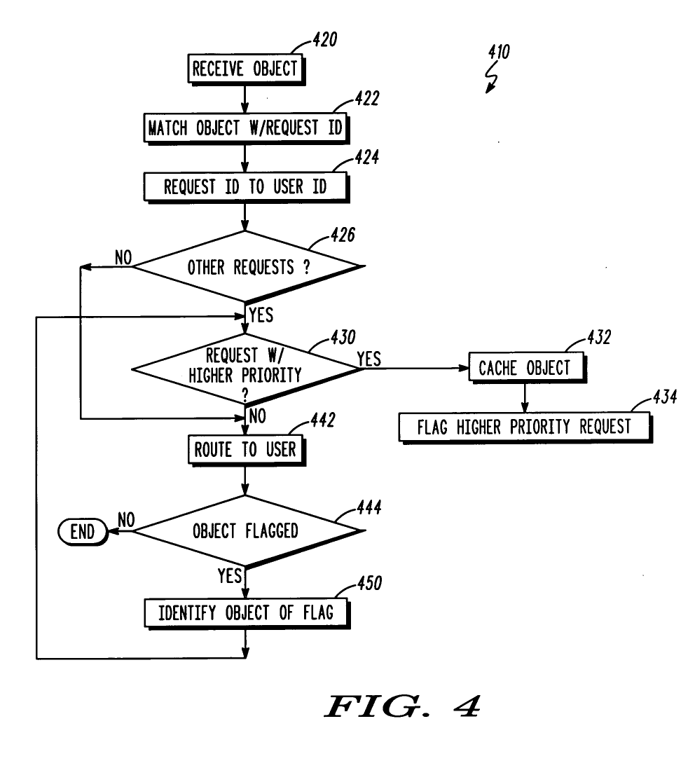

FIG. 4 depicts a simplified flow diagram of an algorithm or process 410 for de-multiplexing received objects to ensure that objects are routed to the requested user, and in some embodiments, so that the objects are routed to the users in a predefined order, such as the order in which the requests were submitted. In step 420 an object is received from a server. In step 422 the received object is matched with a request ID. In step 424, the request ID is matched with a user ID.

In some embodiments where the order of the objects is important and/or critical (e.g., HTTP), the process further includes steps 426, 430, 432 and 434. In step 426 it is determined if other requests are associated with the same user. If it is determined that there are additional requests associated with the user, step 430 is entered where it is further determined if other requests with higher priority from the user are still outstanding. For example, it can be determined if any other requests were submitted prior to identified request. In some embodiments, a priority can be checked by checking a list or FIFO queue for other requests associated with the same user that are higher on the list or FIFO queue. If other requests with higher priority are still pending, step 432 is entered where the object is store, for example in a local cache 220. In step 434, each request ID associated with the same user ID having a higher priority than the request associated with the received object is flagged indicating other objects with lower priority have been received and cached. The priority may be assigned in the order of arrival, so that a second request that arrives after a first request will have a lower priority than the first request. For the case of priority in the order of arrival, it may suffice to flag only the request that immediately preceded the request for the current object, rather than flagging all requests of a higher priority.

If it is determined in step 430 that there are no other outstanding requests with higher priority, or if it is determined in step 426 that there are not additional requests associated with the user (or the order of delivery of objects is not needed), the process continues to step 442 where the received object is routed to the user.

Some embodiments can optionally include step 444 where the process further determines if the routed object was previously flagged (e.g., flagged in step 434 for an earlier received object with a lower priority). If the object is not flagged, the process terminates. If the object was flagged, step 450 is entered where the previously received object associated with the flag is identified. The process 410 then returns to step 430 to determine if any other pending requests remain with a higher priority than the request associated with the identified object.

In some implementations, a number N of fixed persistent connections can be established when a first request is received. In some instances, the proxy can initiate a fixed number of persistent connections in anticipation of users attempting to access a server, attempting to access a scheduled event, and other such anticipations. Alternatively and/or additionally, the proxy can initiate a fixed number of persistent connections based on traffic loads. For example, a proxy can initiate a first five persistent connections upon a first request to a server, and a second five persistent connections once the first five are in use when an additional request is received.

In some implementations of some embodiments, the proxy 140 can dynamically vary the number of persistent connections that are maintained with a given server. The dynamic adjustment of the number of persistent connections can be based on load traffic, system resources, network resources, and other such conditions. The proxy can increase the number of persistent connections to substantially any number, depending on the resources of the proxy, the network and the servers with which the proxy is connecting. Similarly, the proxy can decrease the number of persistent connections depending on demand and/or resources.

In adjusting the number of persistent connections, the proxy can close or release a persistent connection if the connection is idle and/or no longer being used. In some preferred embodiments, the proxy releases a persistent connection if the connection is idle for longer than a threshold period of time. The threshold can depend on many factors including the current load on the server and/or the proxy, the expected load (based on past history), time of day, the demand for other servers, and other such factors. For example, if the load is low and/or the number of persistent connections is low, the system might adjust the threshold time period to a shorter period of time, freeing resources for connections to other servers with higher numbers of requests. Alternatively, if it is expected that there would be a heavy load, the threshold might be longer as additional requests are expected. Additionally, the threshold time period can also be dependent on the objects and/or server being accessed.

The proxy, in some embodiments, can include one or more timers 234, such as an inactivity or idle timer 232, that are activated when a connection becomes idle or is no longer used to communicate a request or receive (or waiting to receive) an object from a server. If the timer reaches a threshold time (e.g., the idle timer counts down a predefined period of time) before a request is communicated over the idle persistent connection, the proxy can release or disconnect the idle persistent connection.

Similarly, the proxy can activate and/or establish new persistent connections with a server when loads on existing persistent connections exceed threshold levels. In some embodiments, the proxy can activate a new persistent connection when all of the existing persistent connections are in use and an additional request is received. Alternatively and/or additionally, the proxy can multiplex or pipeline multiple requests onto existing persistent connections. Once the traffic loads and/or number of requests exceed threshold limits, the proxy can activate one or more additional persistent connections. Multiplexing or pipelining can similarly be used by the proxy when attempts to activate new persistent connections fail, for example, due to loads on a server, the server cannot accept additional connections. In some embodiments, each user is assigned at least a single persistent connection when resources are available.

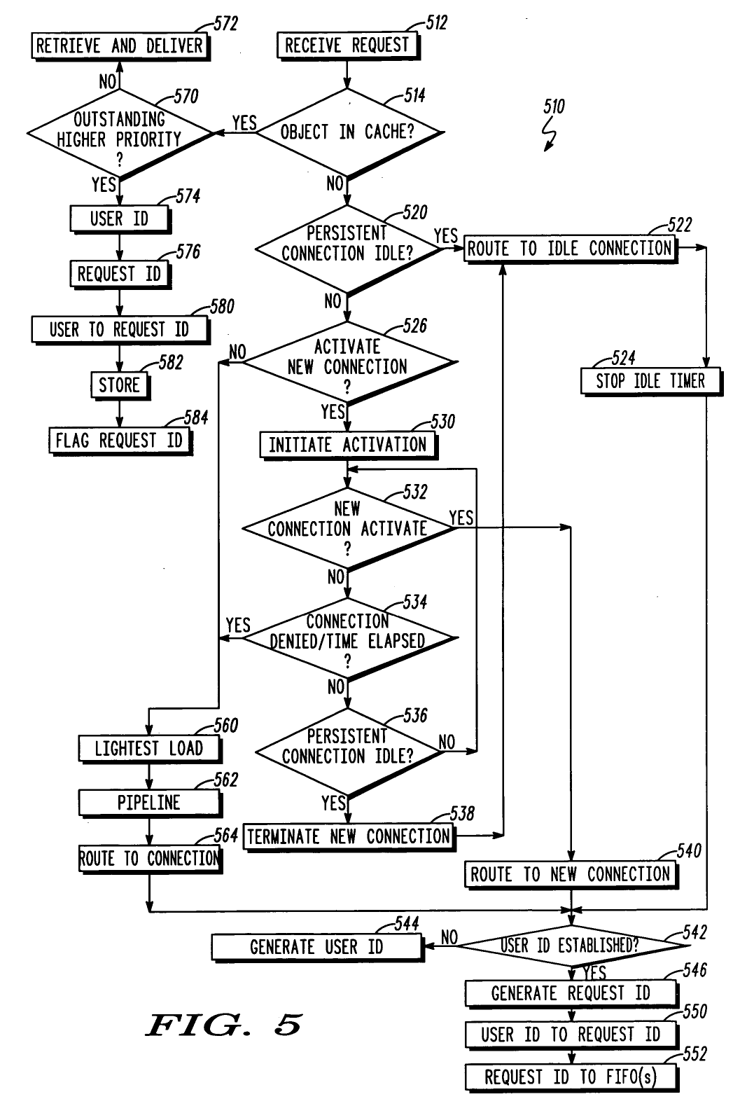

FIGS. 5-7 depict simplified flow diagrams of processes 510, 610 and 710, respectively, for dynamically adjusting the number of persistent connections that are active. Again, the activation of additional persistent connections can be implemented, in some embodiments, when ever a request is received and none of the existing persistent connections are idle. In some embodiments, additional persistent connections can be activated once loads on each connection exceed threshold levels. Other criteria can be used in determining when and/or if the proxy activates or deactivates persistent connections.

Referring to FIG. 5, a request for an object is received from a user in step 512. In step 514 the process determines if the requested object is stored in a cache or other memory. If the object is stored, the process continues, in some embodiments where priority is maintained, to step 570 where it is determined if other requests with higher priority are still outstanding as described fully below. If the object is not cached, the process alternatively continues to step 520 where it is determined if one of the active persistent connections is idle. If a persistent connection is idle, step 522 is entered where the request is routed to the identified idle persistent connection. In some embodiments, the process includes step 524 where an idle timer is stopped, which can be used in decreasing the number of active persistent connections as described below. The process then continues to step 542 where the request is identified and associated with the requesting user.

If it is determined that all of the active persistent connections are in use or are loaded beyond an acceptable threshold, the process alternatively continues to step 526 where it is determined if a new persistent connection can be activated. The determination of whether a new connection can be established can depend on many different criteria and parameters. For example, it can be determined if the proxy has enough capacity and/or resources to activate a new persistent connection. Similarly, it can be determined if the user associated with the received request is already using a persistent connection. Further, it can be determined if the proxy has attempted to activate a persistent connection within a predefined time period and been unable to for various reasons (e.g., because the server is overloaded, the network is overloaded or other similar reasons). If it is determined that an additional persistent connection cannot be established, the process continues to step 562.

If an additional persistent connection can be established, step 530 is entered where the process 510 initiates the activation of the new persistent connection. This activation typically includes the setup (e.g., three-step TCP handshaking) between the proxy and the server when the process is being utilized, for example, in a HTTP and/or WAP system. In step 532 it is determined if the new persistent connection is active. If the connection is activated, the process continues to step 540. If the connection is not yet activated, the process enters step 534 where it is determined if the server has denied the connection and/or a time period for connecting has elapsed. If the connection has been denied or a time period has expired the process 510 proceeds to step 562 where the request is pipelined with other requests on existing active persistent connections. If it is determined that the connection has not been denied and the time period has not expired, the process continues to step 536. In step 536 it is determined if any of the existing persistent connections have become idle. If a persistent connection has become idle (and there are no other pending requests with higher priority), the process enters step 538 where the attempt to establish new persistent connection is terminated and the process returns to step 522 to route the request over the idle persistent connection. If an existing persistent connection has not become idle, the process returns to step 532 to determine if the new persistent connection is active.

In step 540, the request is routed to the newly established persistent connection. In step 542, it is determined if a user ID has been established for the user submitting the current request. In some embodiments, the proxy preferably uses the same user ID for multiple requests from the same client connection. As discussed below, this in conjunction with a request ID allows the proxy to verify that returned objects can be routed to a user in a predefined order, e.g., returned in the order in which requests were received. If a user ID has not been generated or identified, step 544 is entered where a user ID and/or user connection ID is generated and recorded. If the communication protocol does not require the objects be returned in a specific order, step 542 might be skipped. The proxy, however, may utilize the user ID for other purposes besides de-multiplexing/routing requests to users.

In step 546, an ID for the request is generated. The request ID can be based on the destination address attempting to be accessed, the user ID and/or source address, and other such data. In step 550, the request ID is associated with user ID. In step 552 the request ID is stored, for example, added to a list or FIFO queue associated with the persistent connection over which the request was routed. Again, the process 510 shows the IDs being generated following the routing of the request. The generation of the IDs, however, can be performed at substantially any time during the process 510, including simultaneously with other steps, before step 514 and checking if the object is cached, and substantially any time during the process 510. In some embodiments, it is desirable for the request IDs active at a given time for a given user to be different from each other.

If it is determined in step 526 that additional persistent connections should not be established or a connection cannot be established in step 534, the process continues to step 560 where an existing persistent connection having a lightest load is identified. In step 562, the request is pipelined with one or more other requests to be communicated over the existing persistent connection identified has having the lightest load that is already being used to communicate one or more other requests. This pipelining can include for example multiplexing requests from different users over the same persistent connection. In step 564 the request is routed to the connection with the lightest load. The process then returns to step 542 to provide a request ID and associate the request with the user for routing and/or de-multiplexing the object associated with the request once the object is received.

Returning to step 514, if the object is stored, the process continues to step 570 where it is determined if other requests with higher priority are still outstanding. If there are no outstanding requests with higher priorities, the process continues to step 572 where the object is retrieved from memory, and the retrieved object is forwarded to the user. If there are higher priority requests still outstanding, a user ID is generated in step 574 if a user ID has not already been generated, the request is assigned a request ID in step 576, the user and request IDs are associated in step 580, and the request is added to a list or FIFO queue in step 582. In some embodiments, the higher priority request ID are flagged in step 584 indicating that a lower priority objects has already been received.

The delivery of received objects to the users forwarded from the server can be de-multiplexed and/or delivered through substantially any relevant method. In some embodiments, the proxy can utilize the process 410 described above with reference to FIG. 4.

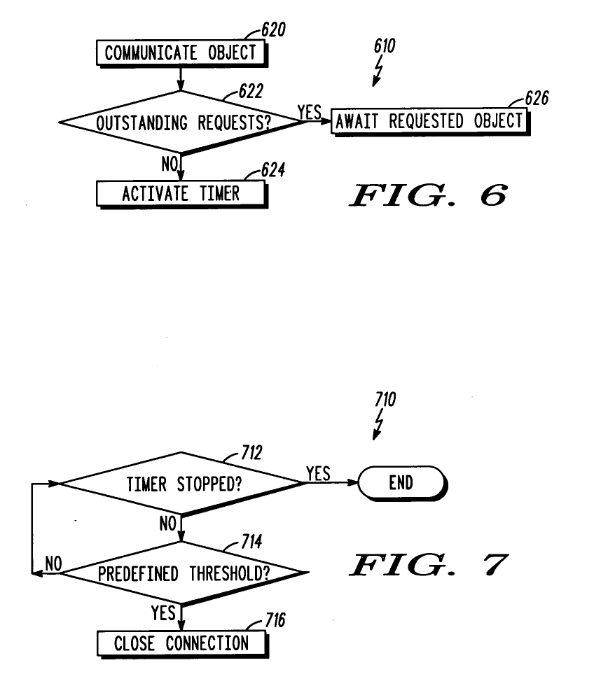

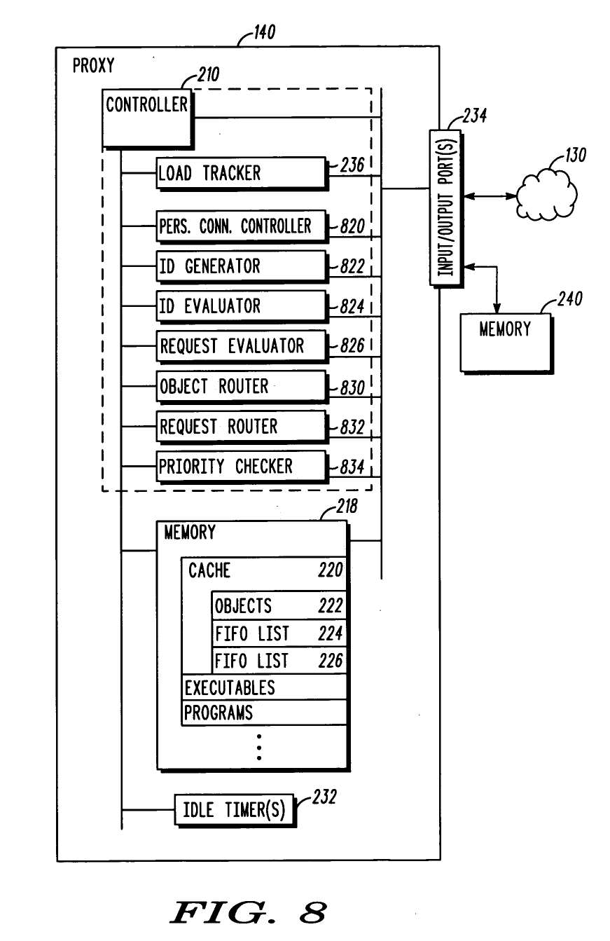

FIGS. 6 and 7 show flow diagram of processes 610 and 710 for activating a timer and terminating a persistent connection, respectively. In step 620 of FIG. 6, a received object is communicated to the user. In step 622, the process 610 determines if other requests are still outstanding on that persistent connection. If there are no other requests still outstanding, step 624 is entered where the process activates an idle timer. If there are outstanding requests, step 626 is entered where the process awaits the receipt of the requested objects.

Referring to FIG. 7, the process 710 initially enters step 712 where it is determined if the idle timer activated in step 624 has been stopped. For example, in step 522 of FIG. 5, the routing of the request to a persistent connection halts the idle timer. If the timer has been stopped, the process 710 terminates. If the timer has not been stopped, step 714 is entered where it is determined if the timer has reached and/or counted down to a threshold time period. If the timer has not reached the threshold, the process returns to step 712 to determine if the timer has been stopped. If the timer has reached the threshold time period, the process closes or disconnects the persistent connection in step 716. Some alternative embodiments do not repeatedly check to see if the time has expired, but instead simply wait for an interrupt from the idle time. If the idle timer counts down to the predefined time period, the time issues an interrupt. Once the interrupt is received, the process enters step 716 where the connection is closed.

In some embodiments, a mixture of dynamic and fixed persistent connections can be utilized. For example, some embodiments may initially open a fixed number of persistent connections opened, and when all of the fixed connections are occupied, an additional fixed number of persistent connections can be opened. Similarly, a fixed number can be opened, and then additional fixed numbers can be opened in anticipation of increased loads (e.g., server providing traffic information).

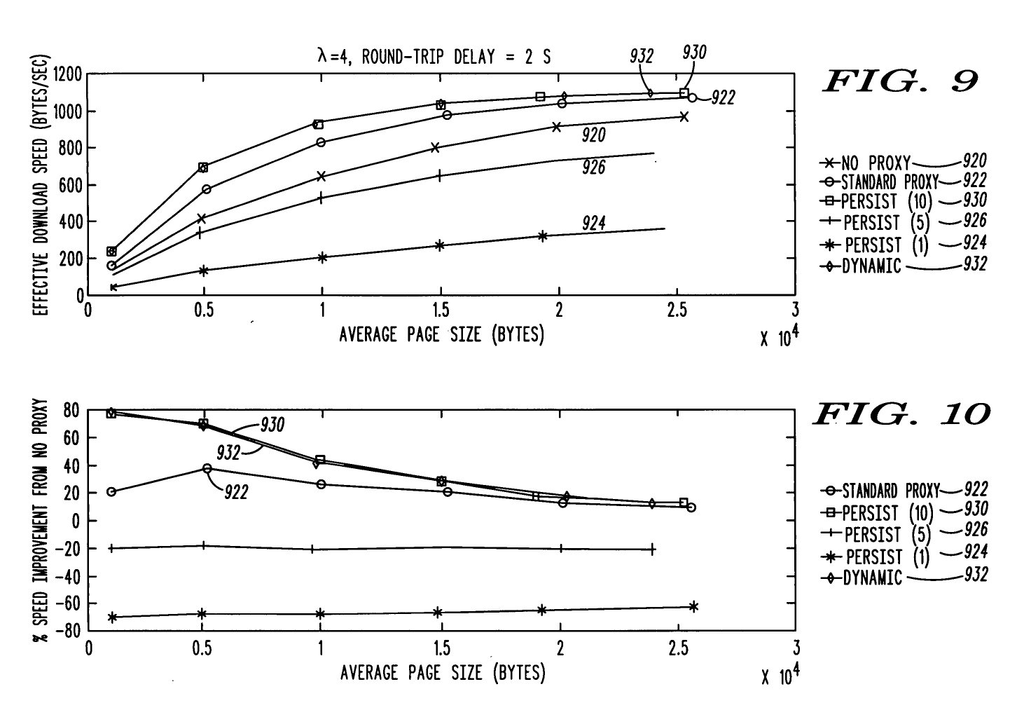

FIG. 8 depicts a simplified block diagram of a proxy 810 according to some embodiments. The proxy 810 can include a controller 210; a memory 218 with one or more caches 220 that store objects 222, lists or FIFO queues 224, 226 and other data and/or information; one or more idle timers 232; input/output ports 234; and load tracker 236, similar to the proxy 140 of FIG. 2. Proxy 810 can additionally include a persistent connection controller 820, an ID generator 822, an ID evaluator 824, a request evaluator 826, an object router 830, a request router 832, a priority checker and other such components. In some embodiments, one or more of the persistent connection controller, ID generator, ID evaluator, request evaluator, object router, request router, and priority checker can be implemented in the controller 210 or other controllers.

The request evaluator 826 can receive the requests from the users and determine if the requested object is in the cache. If the object is in the cache, the request evaluator retrieves the object. The object router 830 then routes the requested object back to the user. In some embodiments, the object router does not route the object back to the user until after verifying that there are no outstanding requests of higher priority for that user, otherwise the request is added to a list or FIFO queue for that user as described below. As described above, the load tracker 236 determines if persistent connections are active for a requested server, and/or monitors the loads of the persistent connections to determine which, if any, of the connections is idle and/or has the lightest load. The persistent connection controller 820 activates new persistent connections and disconnects or releases idle connections. The request router 832 communicates with the load tracker and routes the requests to idle persistent connections and/or persistent connections with the lightest loads.

The ID generator 822 generates user and request IDs and records the IDs in the memory 218. The ID evaluator 824 determines if user IDs have already been established. The ID evaluator further determines which request and user IDs are associated with a received object provided by the object ID evaluator. The priority checker 834 evaluates the received objects to determine if other requests with higher priority are still outstanding and caches the received objects when there are higher priority requests outstanding. These components of the proxy 810 can provide additional functions besides those described as will be apparent to those skilled in the art.

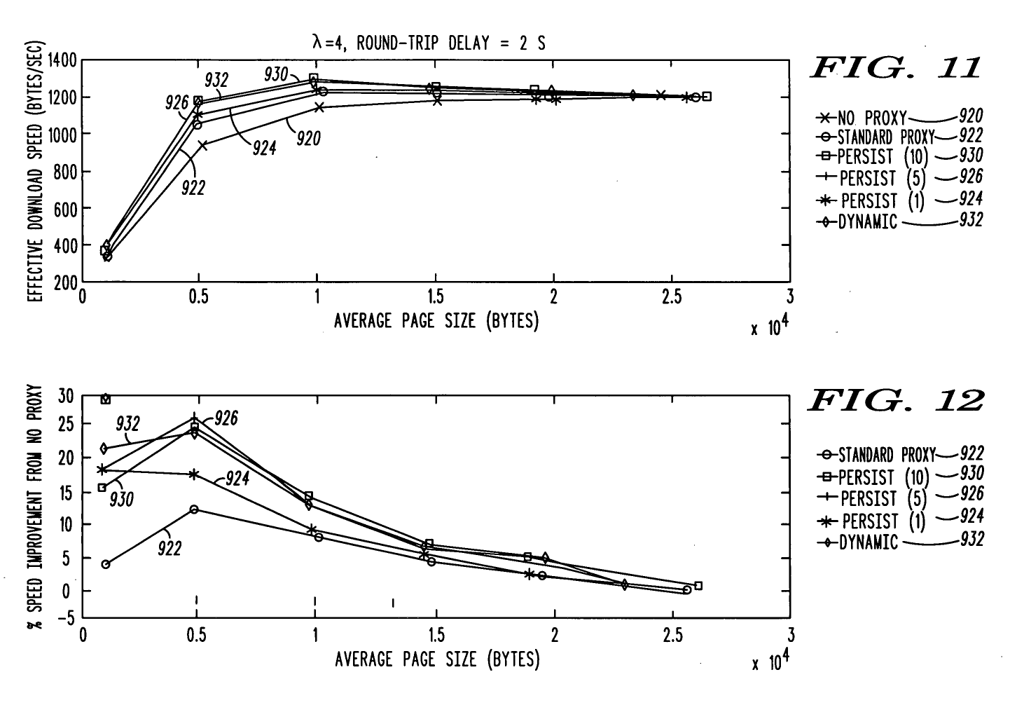

FIGS. 9-12 show simulation results of effective download speeds, based on total bytes transferred divided by the total time to transfer the data, versus average page size. The simulations compare the performance of various proxy schemes for GPRS with requests arriving from wireless devices as a Poisson process at a rate λ of request per second (e.g., λ=4/s and 1/s). The size of the requested object is exponentially distributed and a wireless device will leave or disconnect after receiving a requested object. The proxy schemes include a system having no proxy 920, a system having a standard proxy 922 (that has to open a new connection for each request and does not pipeline), a system according to the present embodiments that provides a single fixed persistent connection 924, a system according to the present embodiments that provides five fixed persistent connections 926, a system according to the present embodiments that provides ten fixed persistent connections 930, and a system according to the present embodiments that dynamically adjusts the number of persistent connections 932. The simulation was preformed in FIGS. 9 and 10 with 2 second effective roundtrip download speed (2 s), with a rate of four requests per second (λ=4/s), with page sizes ranging from 0 to 30 Kbytes. The simulation of FIGS. 11 and 12 were performed with 2 second effective roundtrip download delay time (2 s), with one requests per second (λ=1/s), with page sizes ranging from 0 to 30 Kbytes.

It can be seen in FIG. 9 that the system with ten persistent connections 830 and the system that dynamically adjusts the persistent connections 932 according to present embodiments provide significant speed improvements for relatively small page sizes over systems without a proxy as well as speed improvements over systems with a standard proxy.

FIG. 10 shows a graphical representation of simulation results showing a percentage of speed improvements over a system without a proxy versus average page size. It can be seen that the dynamic system 932 and the system with ten persistent connections 930 according to present embodiments provide up to about an 80% improvement over a system without a proxy, and up to about a 60% improvement over a system with a standard proxy.

FIG. 11 shows a graphical representation of simulation results showing effective download speeds where systems receiving one request per second (λ=1/s). FIG. 12 shows a graphical representation of simulation results showing a percentage of speed improvements over a system without a proxy versus average page size, with one request per second (λ=1). The graphical representations show that the present embodiments provide significant improvement over a system without a proxy as well as system with a standard proxy. For example, the dynamic system 932 provides up to about 22% improvement over a system without a proxy and up to about 15% improvement over the system with a standard proxy.

The simulation results of FIGS. 9-12 demonstrate that the performance of present embodiments providing persistent connections generally increases as the number of persistent connections to the server increases. Further, as the load (average page size and request rate) increases, increased numbers of persistent connections provides improved performance. The system that provides dynamic allocation of persistent connections consistently provides improved performance over systems without proxies and systems with standard proxies. The system that provides dynamic allocation of persistent connections additionally provides improved performance over systems that have fixed numbers of persistent connections while using fewer resources.

Some embodiments can additionally monitor communication systems to determine if the systems are employing persistent connections. In some embodiments, multiple users can be activated to initiate multiple requests directed to a predefined server. The requests from the multiple users can be forwarded to a proxy, and in some embodiments the requests can be pipelined to the proxy. At the server, the requests can be monitored to see how the requests are received from the proxy. For example, the server can detect whether persistent connections are established and/or whether a same persistent connection is used for requesting objects initiated from multiple users. Additionally and/or alternatively, the server can monitor the connections between the proxy and the server to determine how the proxy terminates idle persistent connections. For example, the server can activate an idle timer to track how long idle persistent connections are maintained before being released.

In returning requested objects, the server can send the requested objects so that the proxy receives a user's requested objects out of order. From the user device, it can be determined if the objects are delivered in the order of the requests. This will verify that the proxy is using a de-multiplexing algorithm to return objects back to the users.

The present embodiments can multiplex requests from different users over a common pool of persistent connections from a proxy to a given server or plurality of servers. The present embodiments further provide for the de-multiplexing of responses and/or received objects to route the responses to the correct user and to preserve the order of responses to each user. The dynamic management of the one or more persistent connections provides flexibility and makes the system robust under varying traffic loads. Additionally and/or alternatively, some present embodiments multiplex different users' requests into the same TCP connection allowing downloads to proceed with an open TCP window without going through TCP slow start each time. Dynamic load balancing is also provided when multiplexing to further reduce delay times. By employing multiple persistent connections to a given server, the present embodiment reduce the probability of a second request being delayed due to the delay caused by waiting for the receipt of a large object from a first request in front of the second request.

The present embodiments provide significant improvements in reducing the delay times associated with downloads, such as downloads over the Internet for wireless users. This reduction in delays is particularly evident for smaller object sizes. Simulation results show that for small page sizes (about 1 Kbyte), the effective download speeds of standard proxies are about 20% faster than systems without a proxy, while the effective download speeds for the present embodiments can be up to about 80% faster than in a system without a proxy.

Maintaining persistent connections allows the present embodiments to also provide connectivity to one or more servers under extremely heavy loads. Since a server can only open a limited number of connections, if the server cannot accept new TCP connections, the present embodiments can still pipeline new requests through the existing persistent connections, as opposed to being denied access. Further, the present embodiments also provide the added benefits that standard proxies can provide, including caching, encryption, content-specific compression, and other similar benefits. As such, the benefits of utilizing the persistent connections provided by the present embodiments are over and above any other mechanisms standard proxies can provide. The present embodiments can be utilized with substantially any protocol. For example, the present embodiments are particularly advantageous with HTTP and/or WAP2.0 proxies.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for use in facilitating access with a distributed network, the apparatus comprising:
a plurality of persistent connections to one or more servers in a network; and
a controller that controls communications over the persistent conections;
communication ports coupled with the persistent connections, where at least one of the communication ports receive requests for objects;
wherein the requests are communicated over the plurality of persistent connections and the requested objects are received over the plurality of persistent connections, and at least two of the requests are received from two different users and are communicated over the same persistent connection.

2. The apparatus of claim 1, wherein the controller dynamically adjusts the number of persistent connections.

3. The apparatus of claim 2, further comprising:
an idle timer coupled with the controller, wherein the controller activates the idle timer when a first persistent connection becomes idle, and terminates the first persistent connection when a predefined time period expires before a request for an object is communicated over the first persistent connections.

4. The apparatus of claim 2, wherein the controller activates an additional persistent connection when an additional request is received and the existing plurality of persistent connections are in use, and routes the additional request over the additional persistent connection.

5. The apparatus of claim 2, wherein the controller distributes the requests to be communicated over the plurality of persistent connections such that the requests are routed to persistent connections having lightest loads.

6. The apparatus of claim 1, further comprising:
a cache coupled with the communication ports, wherein a first received object is stored in the cache when a first request associated with the first object has a lower priority than a second request for a second object that has not been received.

7. The apparatus of claim 1, further comprising:
a load tracker coupled with at least one of the communication ports, where the load tracker identifies which of the plurality of persistent connections has a lightest load, wherein the controller communicates with the load tracker and routes a request for an object over a persistent connection having the lightest load according to the load tracker.

8. The apparatus of claim 1, wherein the controller tracks priorities of the received requests and delivers the objects to the requesting user in the order of the priority.

9. A system for use in communicating data with devices, the system comprising:
a proxy comprising:
a controller providing at least some control of the proxy;
a memory coupled with the controller, the memory comprises a cache that stores data; and
a load tracker coupled with the controller, the load tracker provides load information to the controller; and
a plurality of persistent connections coupled with the proxy, where the plurality of persistent connections are connections over a distributed network that are activated and maintained by the proxy.

10. The system of claim 9, wherein the proxy further comprises:
a persistent connection controller coupled with an idle timer, wherein the idle timer determines a period of time for which a first persistent connection is idle, and the persistent connection controller releases the first persistent connection when the first persistent connection is idle for a predefined period of time.

11. The system of claim 9, wherein the proxy further comprises a persistent connection controller coupled with the plurality of persistent connections, the persistent connection controller activates an additional persistent connection when an additional request is received while none of the existing persistent connections are idle.

12. The system of claim 9, wherein the proxy further comprises:
an object identification evaluator coupled with the controller, the object identification evaluator identifies a user associated with a received object; and
an object router coupled with the object identification evaluator, where the object router routes the received object to the user as identified by the object identification evaluator.

13. A method for use in providing client devices with access to a distributed network, the method comprising:
establishing a plurality of persistent connections to servers over a distributed network;
maintaining the plurality of persistent connections as active;
receiving a plurality of requests for objects; and
communicating the plurality of requests over the plurality of persistent connections where a first request and a second request are communicated over a first persistent connection.

14. The method of claim 13, wherein the first request is received from a first client device and the second request is received from a second client device.

15. The method of claim 14, further comprising:
adjusting the number of persistent connections that are maintained as active.

16. The method of claim 15, further comprising:
monitoring a second persistent connection; and
releasing the second persistent connection when the second persistent connection is idle for a predefined period of time.

17. The method of claim 13, further comprising:
receiving an additional request;
determining loading on each of the existing persistent connections;
activating an additional persistent connection when the additional request is received while all of the existing persistent connections are loaded beyond a threshold limit; and
routing the additional request over the additional persistent connection.

18. The method of claim 13, further comprising:
receiving a first object;
determining that a third request is associated with the received first object; and
caching the first object until a second object is received that is associated with a fourth request having a higher priority than the third request.

19. The method of claim 13, further comprising:
receiving a third request;
determining when one of the plurality of active persistent connections is idle; and
routing the third request to an idle persistent connection when one of the plurality of persistent connections is idle.

20. The method of claim 13, further comprising:
receiving an additional request;
determining which of the plurality of persistent connections has the lightest load; and
routing the additional request over a persistent connection with the lightest load.
